(19) United States
(12) Patent Application Publication
(10) Pub. No.: US 2006/0013019 A1
(43) Pub. Date: Jan. 19, 2006

(54) Double-sided light emitting backlight module capable of optically changing a color of light

(76) Inventors: Kuo Jui Huang, Dali City (TW); Chih-Yuan Wang, Shen Kang Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/874,187

(22) Filed: Jun. 24, 2004

(51) Int. Cl. F21V 7/04

(52) U.S. Cl. 362/616

(57) ABSTRACT

A double-sided light emitting backlight module capable of optically changing a color of light includes a lighting light guide board having a light inlet face formed on one side of the lighting light guide board. A light source is disposed adjacent to the light inlet face. A light outlet face is formed on a first plane of the lighting light guide board and a semi-transparent reflective filme is mounted to a second plane of the lighting light guide board opposite to the light outlet face. The semi-transparent reflecting filme includes a color-changing layer for changing the color of the light that shoot through the semi-transparent reflecting filme via the color-changing layer.

### BACKGROUND OF THE INVENTION

1. Field of the Invention

The present invention relates to a double-sided light emitting backlight module, and more particularly to a double-sided light emitting backlight module capable of optically changing a color of light.

2. Description of Related Art

A conventional double-sided light emitting backlight module (8) in accordance with the prior art shown in FIG. 2 comprises a lighting light guide board (81) having a back and a light outlet face (811) formed opposite to the back. A semi-transparent reflecting film (82) mounted to the back of the lighting filme board (81). A light source (83) is disposed laterally adjacent to the lighting light guide board (81). The light ray from the light source (83) is reflected by the semi-transparent reflecting film (82) so that most of the light ray from the light source (83) shoots through the light outlet face (811) and used as a backlight of a first display module (91), and little light ray from the light source directly shoots through the semi-transparent reflecting film (82) and used as a backlight of a second display module (92). The first display module (91) faces the light outlet face (811) and the second display module (92) faces the semi-transparent film (82).

The light ray from each face of the lighting light guide board (81) has a same color that usually is white light. However, most of the marketed cell phone has two screens. One is a color screen and another is a monochrome screen. The screens of the cell phone become dull and unchangeable because the cell phone must have a monochrome screen when the conventional double-sided light emitting backlight module (8) is used to a cell phone.

For the monochrome screen to shown a colorful ground, the conventional double-sided light emitting backlight module (8) needs to include a backlight module with a different color or a color changing element. The two ways for the monochrome screen to shown a colorful ground will greatly increase the manufacturing cost and the thickness of the backlight module.

The present invention has arisen to mitigate and/or obviate the disadvantages of the conventional double-sided light emitting backlight module.

### SUMMARY OF THE INVENTION

The main objective of the present invention is to provide an improved double-sided light emitting backlight module capable of optically changing a color of light for changing a color of a backlight of a monochrome display module.

To achieve the objective, the double-sided light emitting backlight module in accordance with the present invention comprises a lighting light guide board having a light inlet face formed on one side of the lighting light guide board. A light source is disposed adjacent to the light inlet face. A light outlet face is formed on a first plane of the lighting light guide board and a semi-transparent reflective filme is mounted to a second plane of the lighting light guide board opposite to the light outlet face. The semi-transparent reflecting filme includes a color-changing layer for changing the color of the light that shoot through the semi-transparent reflecting filme via the color-changing layer.

Further benefits and advantages of the present invention will become apparent after a careful reading of the detailed description with appropriate reference to the accompanying drawings.

### BRIEF DESCRIPTION OF THE DRAWINGS

FIG. 1 is a cross-sectional view of a double-sided light emitting backlight module capable of optically changing a color of light in accordance with the present invention; and

FIG. 2 is a cross-section view of a conventional double-sided light emitting backlight module in accordance with the prior art.

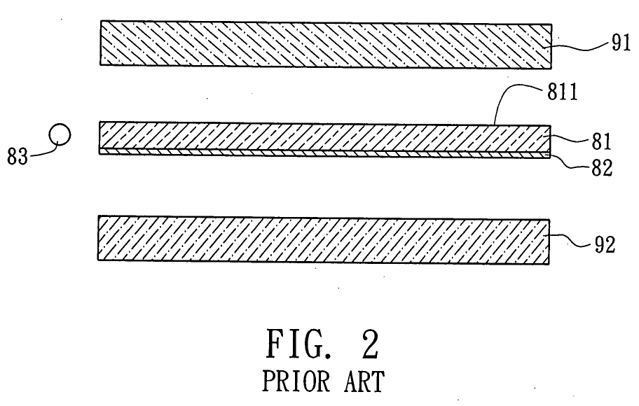

### DETAILED DESCRIPTION OF THE INVENTION

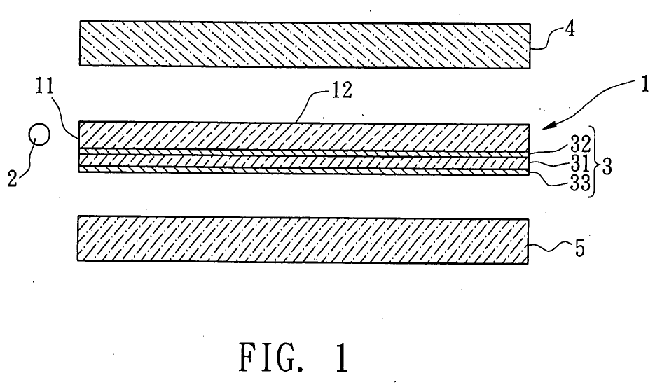

Referring to the drawings and initially to FIG. 1, a double-sided light emitting backlight module capable of optically changing a color of light in accordance with the present invention comprises a lighting light guide board (1) having a light inlet face (11) formed on one side of the lighting light guide board (1). A light source (2) is disposed adjacent to the light inlet face (11). A light outlet face (12) is formed on a first plane of the lighting light guide board (1) and a semi-transparent reflective filme (3) is mounted to a second plane of the lighting light guide board (1) opposite to the light outlet face (12). The semi-transparent reflecting filme (3) includes a semi-transparent reflecting layer (32), a transparent basic layer (31) and a color-changing layer (33) sequentially piled up one after one relative to the second plane of the lighting light guide board (1) for changing the color of the light that shoot through the semi-transparent reflecting filme (3) via the color-changing layer (33).

For using the double-sided light emitting backlight module of the present invention, a color display module (4) and a monochrome display module (5) are arrange in groups to the present invention. The color display module (4) is arranged to face the light outlet face (12) and the monochrome display module (5) is arranged to face the semi-transparent reflecting filme (3).

For example, the light from the light source (2) is white light, the color-changing layer (33) is for orange color and the semi-transparent reflecting layer (32) has a low transparency. Most of the light ray from the light source (2) is reflected by the semi-transparent reflecting layer (32) of the semi-transparent reflecting filme (3), shoots through the light outlet face (12) and is used as a backlight of the color display module (4). Some light ray from the light source (2) shoots through the semi-transparent reflecting filme (3), becomes orange color light ray due to the color-changing layer (33) and is used as a background of the monochrome display module (5).

As described above, the double-sided light emitting backlight module in accordance with the present invention can provide two backlights with different colors due to the semi-transparent reflecting filme (3). In addition, the transparency of the semi-transparent reflecting layer (32) of the semitransparent reflecting filme (3) can be set between 5% and 90% according to the color display module (4) and the monochrome display module (5).

Although the invention has been explained in relation to its preferred embodiment, it is to be understood that many other possible modifications and variations can be made without departing from the spirit and scope of the invention as hereinafter claimed.

What is claimed is:

1. A double-sided light emitting backlight module capable of optically changing a color of light, comprising a lighting light guide board having a light inlet face formed on one side of the lighting light guide board, a light source disposed adjacent to the light inlet face, a light outlet face formed on a first plane of the lighting light guide board and a semi-transparent reflective filme mounted to a second plane of the lighting light guide board opposite to the light outlet face, the semi-transparent reflecting filme including a color-changing layer for changing the color of the light that shoot through the semi-transparent reflecting filme via the color-changing layer.

2. The double-sided light emitting backlight module as claimed in claim 1 wherein the semi-transparent reflecting filme further comprises a transparent basic layer and a semi-transparent reflecting layer, and the semi-transparent reflecting layer, the transparent basic layer and the color-changing layer being sequentially piled up one after one relative to the second plane of the lighting light guide board.
